(19) United States
(12) Patent Application Publication
(10) Pub. No.: US 2013/0277632 A1
(43) Pub. Date: Oct. 24, 2013

(54) Lifting device, particularly for lifting wheels and the like, for wheel balancing and tire moving machines

(71) Applicant: CEMB S.P.A., Mandello Del Lario (IT)

(72) Inventor: Carlo Buzzi, Mandello Del Lario (IT)

(21) Appl. No.: 13/986,821

(22) Filed: Jun. 10, 2013

Related U.S. Application Data
(63) Continuation-in-part of application No. 12/453,797, filed on May 22, 2009.

(30) Foreign Application Priority Data
Sep. 3, 2008 (IT) MI2008A001577

(51) Int. Cl. B66F 7/06; B66F 7/08

(52) U.S. Cl. CPC B66F 7/065; B66F 7/085
USPC 254/93 R

(57) ABSTRACT

A lifting device, particularly for lifting wheels of vehicles and the like, for wheel balancing and tire removing machines, comprising a scissor-like frame, which is interposed between at least two flat and mutually parallel elements for their mutual translational motion as a consequence of the action of motor means functionally associated with the scissor-like frame, the lifting device further comprising a cam-type profiled element, which can be engaged functionally with the motor for dynamic and static balancing between the thrust force generated by the motor and the contrast force of the scissor-like frame in addition to the weight of the object to be lifted, which is arranged on one of the two flat and parallel elements, in all the operating positions of the lifting device.

This is a continuation-in-part of U.S. patent application Ser. No. 12/453,797, filed on May 22, 2009.

The present invention relates to a lifting device, particularly for lifting wheels of vehicles and the like, for wheel balancing and tire removing machines.

### BACKGROUND OF THE INVENTION

It is common practice, in the field of vehicle repair shops, to use wheel balancing machines on which it is necessary to mount the wheel to be balanced by inserting a shaft, arranged at a distance from the ground that ranges on average from 700 mm to 800 mm, in the hole of such wheel.

Moreover, during the mounting of the wheel on the balancing machine, the wheel is centered on the above cited shaft by means of a conical device that acts on the central hole.

This known method for mounting the wheel on a balancing machine suffers a number of drawbacks. Among these, one must include the fact that the wheel, which can weigh up to 70 kg, is generally lifted manually by the operator, with an obvious effort for the operator and with a consequent risk of injury.

Another drawback of this known mounting method consists in that during the centering steps the conical device, on which the wheel is mounted, is subjected to a considerable vertical stress that is due substantially to the weight of the wheel proper and this can easily compromise the perfect centering of the wheel on the balancing machine and therefore damage the quality of the measurement significantly.

In order to obviate these drawbacks, lifting devices are commercially available which, however, suffer considerable problems that make their use scarcely practical.

In particular, it is usually very difficult to bring the wheel to the exact centering position while bearing the weight of such wheel; pneumatic systems of the elastic type are in fact known which partially avoid the need to position the wheel exactly in terms of height.

In this manner it is possible to allow a relative elasticity to the system, so that the operator can easily fit the wheel on the conical device of the balancing machine.

However, these systems do not compensate exactly for the weight of the wheel over the entire stroke of the lifting device and therefore make it difficult to use, requiring a calibration thereof that depends on the weight of the wheel.

The same problems can also be observed in machines that are similar to wheel balancing machines. One example is constituted by tire removing machines, which require a step for positioning and centering the wheel in order to allow correct use of the machine.

### SUMMARY OF THE INVENTION

The aim of the present invention is to eliminate the drawbacks cited above by providing a lifting device, particularly for lifting wheels of vehicles and the like, for wheel balancing and tire removing machines, which allows to compensate automatically for the weight of the wheel over the entire stroke of such lifting unit, minimizing the work performed by the operator.

Within this aim, an object of the present invention is to provide a lifting device that is simultaneously inexpensive, compact in size and simple to use.

This aim, as well as these and other objects that will become better apparent hereinafter, are achieved by a lifting device, particularly for lifting wheels of vehicles and the like, for wheel balancing machines and tire removing machines, comprising a scissor-like frame interposed between at least two flat and mutually parallel elements for their mutual translational motion as a consequence of the action of motor means functionally associated with said scissor-like frame, characterized in that it comprises cam-type profiled means which can be engaged functionally with said motor means for dynamic and static balancing between the thrust force generated by said motor means and the contrast force of said scissor-like frame in addition to the weight of the object to be lifted in all the operating positions of the lifting device, said object to be lifted being arranged on one of said two flat and parallel elements.

### BRIEF DESCRIPTION OF THE DRAWINGS

Further characteristics and advantages of the present invention will become apparent from the description of a preferred but not exclusive embodiment of a lifting device, particularly for lifting wheels of vehicles and the like, for wheel balancing and tire removing machines, according to the invention, illustrated by way of non-limiting example in the accompanying drawings, wherein:

FIG. 1 is a side elevation view of an embodiment of a lifting device, particularly for lifting wheels of vehicles and the like, for wheel balancing and tire removing machines, according to the present invention;

FIG. 2 is a side elevation view of a detail of the lifting device shown in FIG. 1;

FIG. 3 is a schematic view of the force involved during the operation of the lifting device shown in FIG. 1.

### DESCRIPTION OF THE PREFERRED EMBODIMENTS

With reference to the figures, a lifting device, particularly for lifting wheels of vehicles and the like, for wheel balancing and tire removing machines, generally designated by the reference numeral 1, comprises a scissor-like frame 2, which is interposed between at least two flat and mutually parallel elements 3 and 4 for their mutual translational motion as a consequence of the action of motor means 5 that are functionally associated with the scissor-like frame 2.

More precisely, the two elements 3 and 4 are arranged in a horizontal position and respectively define the lower base of the lifting device 1 and the resting surface thereof on which a wheel 6 or any other object to be lifted is to be rested.

As regards the scissor-like frame 2, it is constituted by two rods 2a and 2b, which are hinged to each other so as to form an X-like shape and are hinged at one of their ends respectively to the lower base 3 or to the resting surface 4.

The remaining end of the two rods 2a and 2b is also functionally connected to the lower base 3 or to the resting surface 4, providing a carriage-like coupling so as to allow the scissor-like frame 2 to open or close as a consequence of the action of the motor means 5.

According to the invention, cam-type profiled means 7 are provided that can be engaged functionally with the motor means 5 for dynamic and static balancing between the thrust force generated by the motor means 5 and the resisting force of the scissor-like frame 2 in addition to the weight of the object to be lifted in all the operating positions of the lifting device.

More precisely, the motor means 5 comprise at least one pneumatic actuator which can be pivoted to one of the two elements 3 and 4 with the movable element that can engage functionally the cam-type profiled means 7 and the scissor-like frame 2.

The pneumatic actuator works according to the known rule of adiabatic expansion of the thermodynamics:

P*V=const

where P and V are respectively the pressure and the volume of the air contained in the cylinder of the actuator.

Advantageously, the means 7 comprise a body 8 that has a cam-type profile and is arranged between the lower base 3 and the rod 2a so that at least one bearing 9, associated with the movable element of the pneumatic actuator, can slide in contact with the outer profile of the cam-type profiled body 8 and simultaneously with a second profile defined by the rod 2a of the scissor-like frame 2.

In this manner, the bearing 9 is wedged between the two profiles, and once the pneumatic actuator has been activated, it pushes both against the body 8 and against the rod 2a, as shown in FIG. 3, causing the opening or closing of the scissor-like frame 2.

As regards feeding of the pneumatic actuator, supply means are provided which comprise, in addition to a suitable pneumatic system, also at least one auxiliary tank 10, which is connected to the actuator so as to ensure the pressure needed to lift the wheel 6.

More precisely, by using a double-acting actuator it is possible to fill the auxiliary tank 10 with the quantity of air needed to allow a plurality of consecutive lifting and lowering cycles.

As regards actuation of the actuator, actuation means are provided which can be associated directly with a wheel balancing machine or with a tire removing machine.

In particular, the actuation means can be a cylinder.

In order to obtain the compensation of the weight indifferently for the entire lifting stroke it is necessary that the work done by the air in the cylinder be matched to the variation in potential energy of the weight raised on the lift. This can be obtained by way of a correct design of the cam with regard to the force available on the cylinder.

An embodiment is herewith discussed.

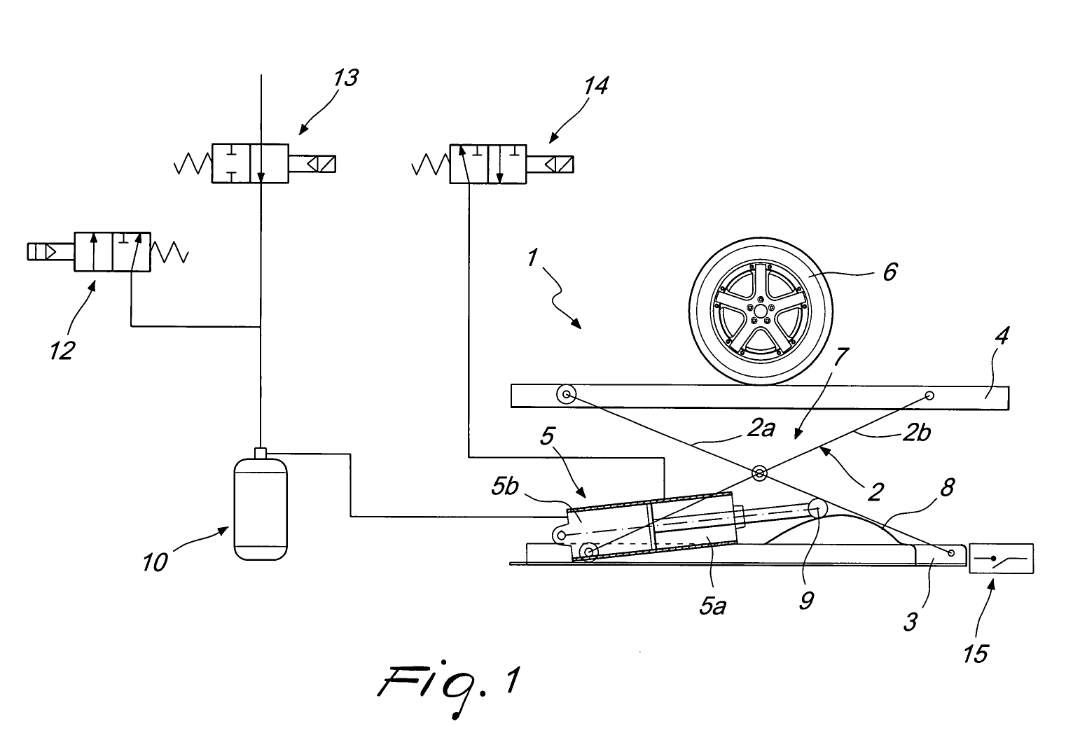

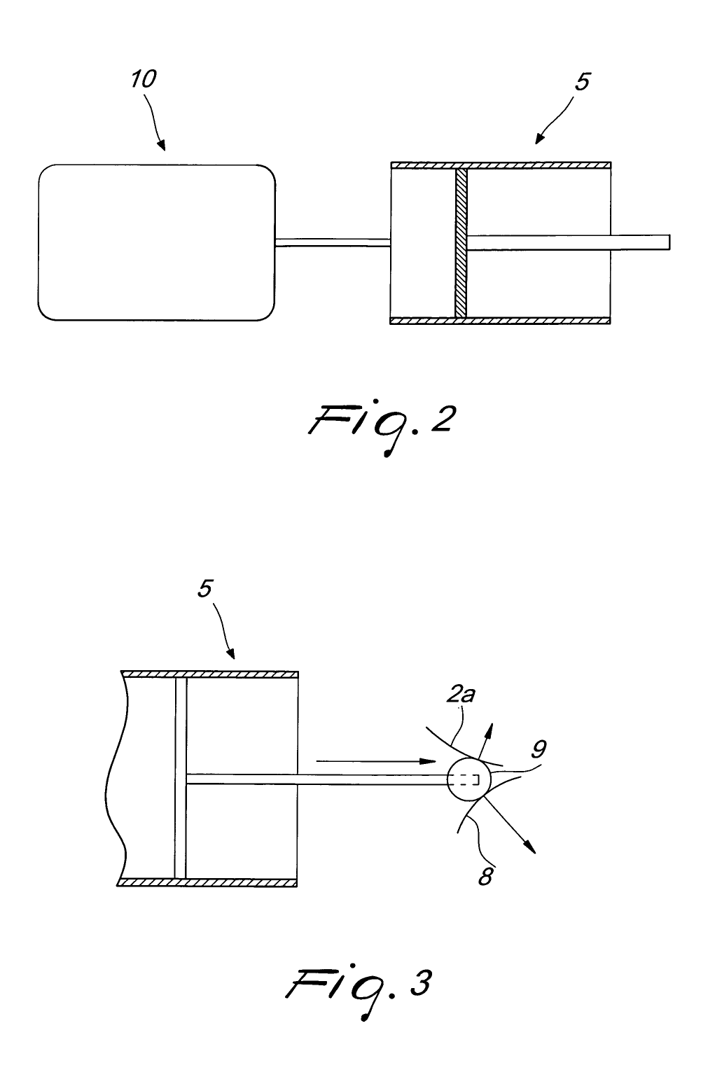

The cylinder 5 as in FIG. 1 is connected to the auxiliary 10 of known dimensions which acts as an air reservoir during the expansion over the entire stroke of the cylinder. The operation of the device is based on the expansion of the air in the auxiliary tank 10 and in the cylinder 5, without topping-up the air in the circuit, after a movement (even minimal) from the lower position of the lift has been obtained. The quantity of air under pressure put into the tank in order to obtain the initial movement constitutes an energy reserve that can move the weight along the whole stroke of the lift and, in practice, automatically store the compensated weight.

The cam 8 can be designed by designing its shape so that the Boyle-Mariotte law is observed at every point of the lift stroke, where the work is

mg·(h2−h1)=K·ln(V2/V1)

where mg is the weight to be moved, h is the height movement, K is a constant, and V₁ and V₂ are the volumes in the circuit at the cylinder 5 and tank 10.

From this formula, which links the vertical movement of the mass to be moved with the volume in the circuit, the shape of the cam that ensures the desired operation can be derived.

The device proposed for the purposes of example can operate using a particular use sequence of valves, in order to achieve the aim of cancelling the weight of the wheel.

In FIG. 1 the cylinder 5 is initially without any air supply from both chambers 5a and 5b. The chamber 5b is connected to the auxiliary tank 10; the tank 10 can be fed by the compressed air supply via an electric spigot 13.

Such spigot 13 is automatically closed as soon as a switch 15 is actuated upon a minimal vertical movement of the lift; at this moment in time, the thrust force of the cylinder is equivalent to the gravitational force of the lift and of the weight upon it.

In this way the circuit stores the quantity of air under pressure that is necessary and sufficient to move the lift and the weight upon it.

The pressure present in this stage of the operating cycle is therefore representative of the weight to be lifted. Thanks to the design that links the shape of the cam in the lift with the volume of the pneumatic circuit, the weight on the lift is automatically compensated for the entire stroke thereof. The size of the tank 10 is irrelevant to the operation of the system, but its volume conditions the shape of the cam profile calculated with the method described above. The system works the same way if a tank of infinite size is emulated, thanks to a system implemented for example with a reference pneumatic pressure reducer (for example, SMC EVEX 1900-20F) where the pressure reference is stored in an auxiliary tank to which the supply is cut as soon as a minimal vertical movement of the lift is obtained. Similar operation can be obtained with a mechanically operated pressure reducer where the pressure is varied by a means, for example electric, which is stopped as soon as sufficient pressure is reached to obtain a minimum vertical movement of the lift. In this way the pressure on the actuator cylinder will be kept constant for the entire stroke of the lift, thus emulating a tank of infinite size. Obviously the cam will be calculated in consideration of the fact that the pressure is constant throughout the stroke.

In particular, in practical use the wheel, manually moved vertically with its weight almost completely supported by the lift, can be moved without effort to the height of the shaft of the wheel balancing machine.

Once the wheel is fixed thereon, the lift as shown in FIG. 1 can be commanded to descend by injecting, through a spigot 14, compressed air into the chamber 5b of the cylinder 5. By doing this the lift can descend and the air in the chamber of the cylinder 5 and in the auxiliary tank 10 is compressed, but without leaving the circuit. For this reason, in the step where the wheel has to be brought back to ground level after balancing, it is possible to open the spigot 14 discharging the chamber 5b so that the compressed air in the circuit can again actuate the lift, which will rise against the wheel fixed on the shaft of the wheel balancing machine with exactly the force of the compression of the air in the circuit, which is identical to the force defined at the beginning of the cycle with the closing of the spigot 13.

The wheel therefore, supported with a force equal to its weight, can be easily taken off the centering device of the wheel balancing machine and lowered to the ground by simple manual pressure.

Once the ground is reached and the switch 15 is reached, a solution is to empty the circuit using a valve 12.

The sequence described or a similar one adapted to a different work cycle of the wheel balancing machine can be implemented by way of a simple programmable electronic unit.

Operation of the lifting device 1, particularly for lifting wheels of vehicles and the like, for wheel balancing and tire removing machines, is thus clearly desumable from the foregoing.

In particular, it must be stressed that by pressurizing the compressed air motor means 5 it is possible to “cancel out” the weight of the wheel 6 or of the object being lifted, allowing a lifting or lowering thereof in any position within the stroke of the lifting device 1.

More precisely, the outer profile of the cam-type profiled body 8, along the lifting stroke of the lifter, is such as to compensate exactly for the reduction in pressure caused by the expansion of the gas contained in the pneumatic actuator.

This balance is achieved as soon as the lifter moves from the initial low position.

This position is then kept in balance by the force of the piston according to rule (1) and the reaction force of the weight of the wheel 6 to be lifted, without introducing further air, throughout the stroke.

The force provided by the pneumatic actuator decreases, reducing the pressure and increasing the volume, and simultaneously the force transmitted by means of cams, which keeps the weight balanced, decreases equally.

Stated in other words, the first fixed cam profile is determined as a function of the volume of the pneumatic actuator and of the means for supplying compressed air to the cylinder of the pneumatic actuator, the volume of the compressed air introduced in the cylinder being such as to determine the beginning of the stroke of the lifting device and such volume being maintained throughout the stroke of the lifting device.

In practice it has been found that the lifting device, particularly for lifting wheels of vehicles and the like, for wheel balancing machines and tire removing machines, according to the present invention, fully achieves the intended aim and objects, since it allows to move a wheel or any other object to be lifted, entailing minimal effort for the operator.

A further advantage of the lifting device according to the present invention consists in that it is simple to manufacture, entailing low costs.

Another advantage of the lifting device according to the present invention consists in that it can be integrated, at the power supply and management level, with an existing wheel balancing or tire removing machine.

The lifting device, particularly for lifting wheels of vehicles and the like, for wheel balancing machines and tire removing machines, thus conceived is susceptible of numerous modifications and variations, all of which are within the scope of the appended claims.

All the details may further be replaced with other technically equivalent elements.

In practice, the materials used, so long as they are compatible with the specific use, as well as the contingent shapes and dimensions, may be any according to requirements and to the state of the art.

The disclosures in Italian Patent Application no. MI2008A001577, from which this application claims priority, are incorporated herein by reference.

What is claimed is:

1. A lifting device, particularly for lifting wheels of vehicles and the like, for wheel balancing and tire removing machines, comprising
a scissor-like frame,
at least two flat and mutually parallel elements comprising a lower base element and a resting surface element for supporting a weight thereon, said scissor-like frame being interposed between said at least two flat and mutually parallel elements,
at least one pneumatic actuator functionally associated with said scissor-like frame, said pneumatic actuator comprising a cylinder and a movable piston which is movably arranged inside said cylinder,
means for supplying compressed air to said cylinder of said pneumatic actuator,
a first fixed cam profile,
a second cam profile of said scissor-like frame,
at least one bearing connected with said movable piston of said pneumatic actuator and arranged to slidably engage simultaneously said first fixed cam profile and said second cam profile for selective opening or closing of said scissor-like frame and for providing a mutual translational motion of said at least two flat and mutually parallel elements,
said pneumatic actuator operating such that a pressure of air contained inside said cylinder of said pneumatic actuator multiplied by a volume of said air contained inside said cylinder is constant,
said first fixed cam profile being determined as a function of the volume of the pneumatic actuator and of the means for supplying compressed air to the cylinder of the pneumatic actuator, the volume of said compressed air introduced in said cylinder being such as to determine the beginning of the stroke of the lifting device and such volume being maintained throughout the stroke of the lifting device.

2. The lifting device according to claim 1, wherein said pneumatic actuator is pivoted to said lower base element of said two flat and parallel elements, said first fixed cam profile being fixed to said lower base element.

3. The lifting device according to claim 1, further comprising actuation means for actuating said means for supplying compressed air to said cylinder of said pneumatic actuator.

4. The lifting device according to claim 1, wherein said means for supplying compressed air to said cylinder of said pneumatic actuator comprise at least one auxiliary air tank connected to said cylinder of said pneumatic actuator.

5. The lifting device according to claim 1, wherein said first fixed cam profile cam is designed so that the Boyle-Mariotte law is observed at every point of the lift stroke, where the work is
mg·(h2−h1)=K·ln(V2/V1)
where mg is the weight to be moved, h is the height movement, K is a constant, and V₁ and V₂ are the volumes in the circuit at the cylinder 5 and tank 10

6. A method for actuating a lifting device as claimed in claim 1, comprising the steps of:
providing pressurized air to said cylinder by means of said means for providing pressurized air;
stopping the supply of pressurized air as soon as the lifting device starts the lift; the provided volume of pressurized air being maintained constant during the whole stroke of the lifting device;
the provided volume of pressurized air being sufficient to move the weight during the whole stroke of the lifting device.
